(19) United States
(12) Patent Application Publication
(10) Pub. No.: US 2026/0081528 A1
(43) Pub. Date: Mar. 19, 2026

(54) POWER SUPPLY DEVICE

(71) Applicant: ROHM CO., LTD., Kyoto (JP)

(72) Inventor: Takatsugu WACHI, Kyoto (JP)

(21) Appl. No.: 19/396,591

(22) Filed: Nov. 21, 2025

Related U.S. Application Data
(63) Continuation of application No. PCT/JP2024/014538, filed on Apr. 10, 2024.

(30) Foreign Application Priority Data
May 31, 2023 (JP) 2023-089918

(51) Int. Cl. H02M 3/158

(52) U.S. Cl. CPC H02M 3/158

(57) ABSTRACT

A first converter includes first to fourth switching elements connected in series from a reference node toward a node fed with an input voltage, a flying capacitor, an intermediate capacitor, and a first inductor. The intermediate capacitor is provided between a connection node between the second and third switching elements and the reference node. The second converter includes a switching output stage connected to the connection node between the second and third switching elements, and a second inductor. A control circuit produces an output voltage lower than the input voltage by controlling the states of the switching elements and of the switching output stage.

### DESCRIPTION

### CROSS-REFERENCE TO RELATED APPLICATIONS

This nonprovisional application is a continuation application of International Patent Application No. PCT/JP2024/014538 filed on April 10, 2024, which claims priority to Japanese Patent Application No. 2023-089918 filed on May 31, 2023, the entire contents of which are hereby incorporated by reference.

### TECHNICAL FIELD

The present disclosure relates to a power supply device.

### BACKGROUND ART

As one type of power supply device employing a switching element, a multiphase converter is known. A multiphase converter offers high output electric power and low output ripples.

### Citation List

### Patent Literature

Patent Document 1: JP 2022-6829 A1

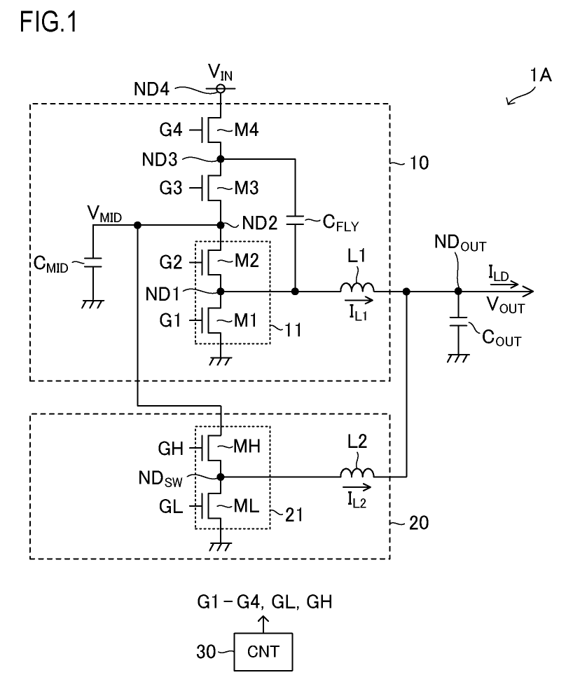

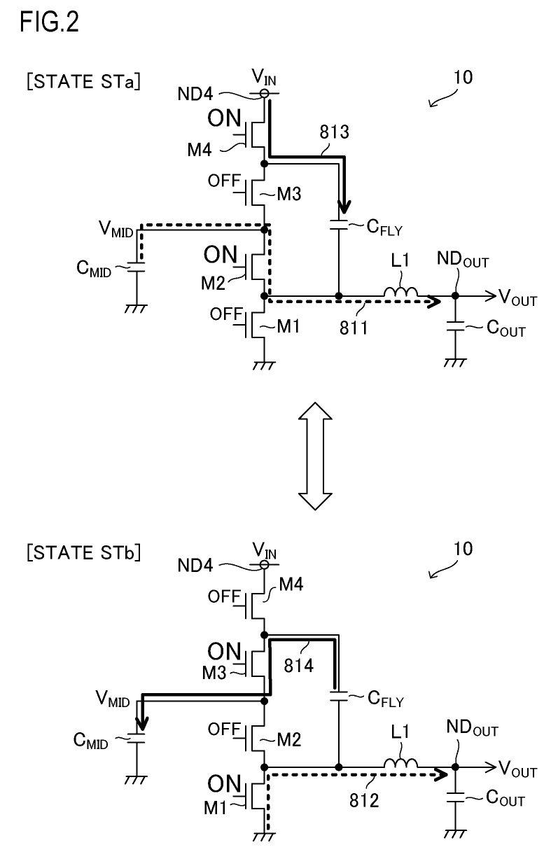

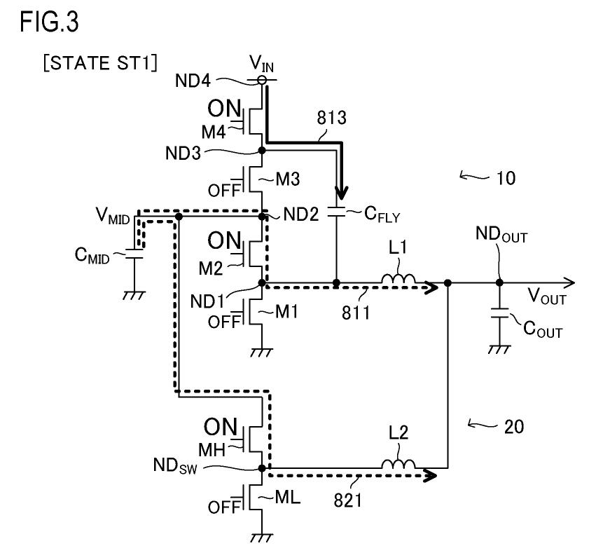

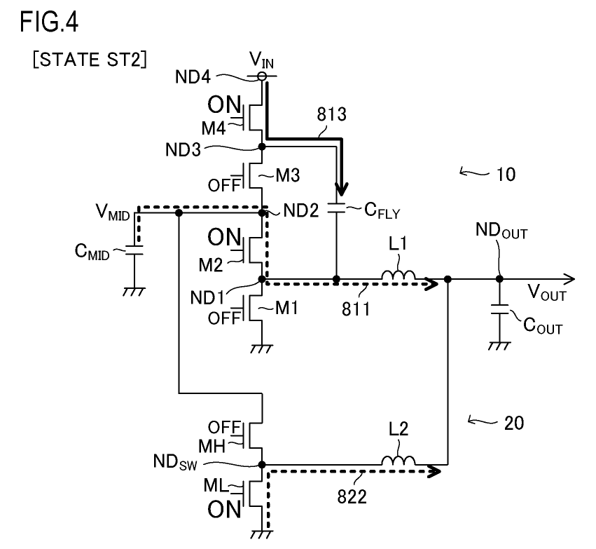

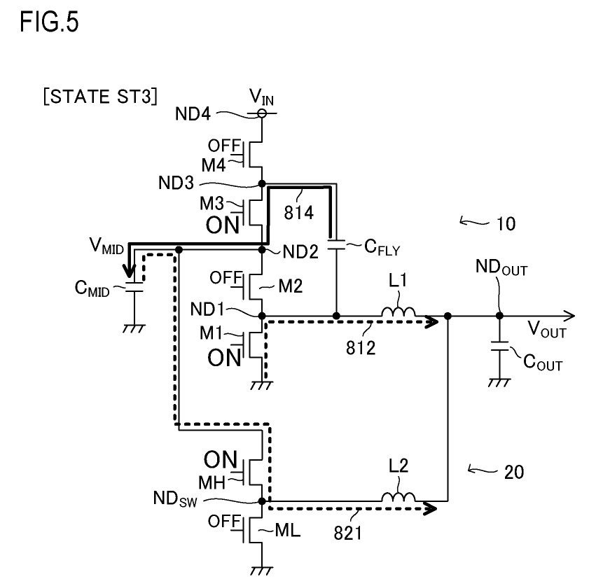

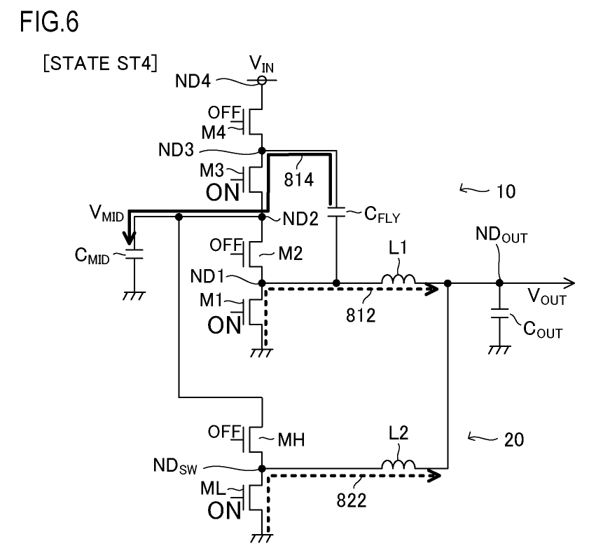

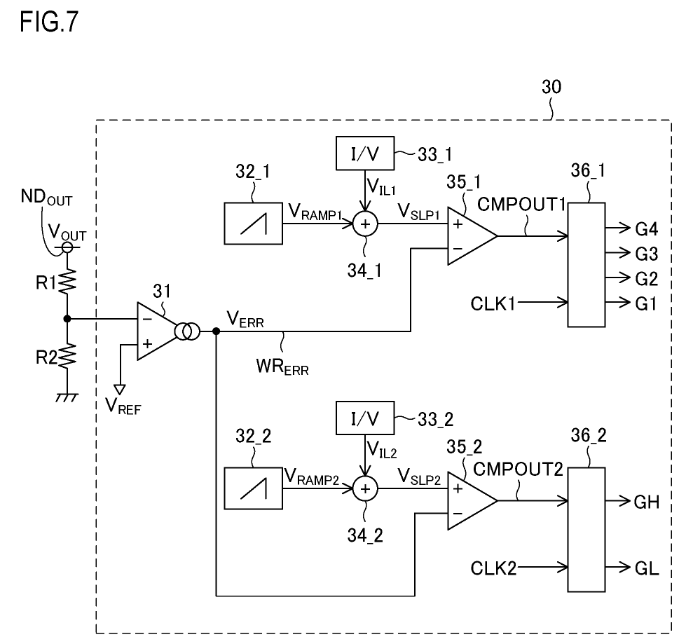

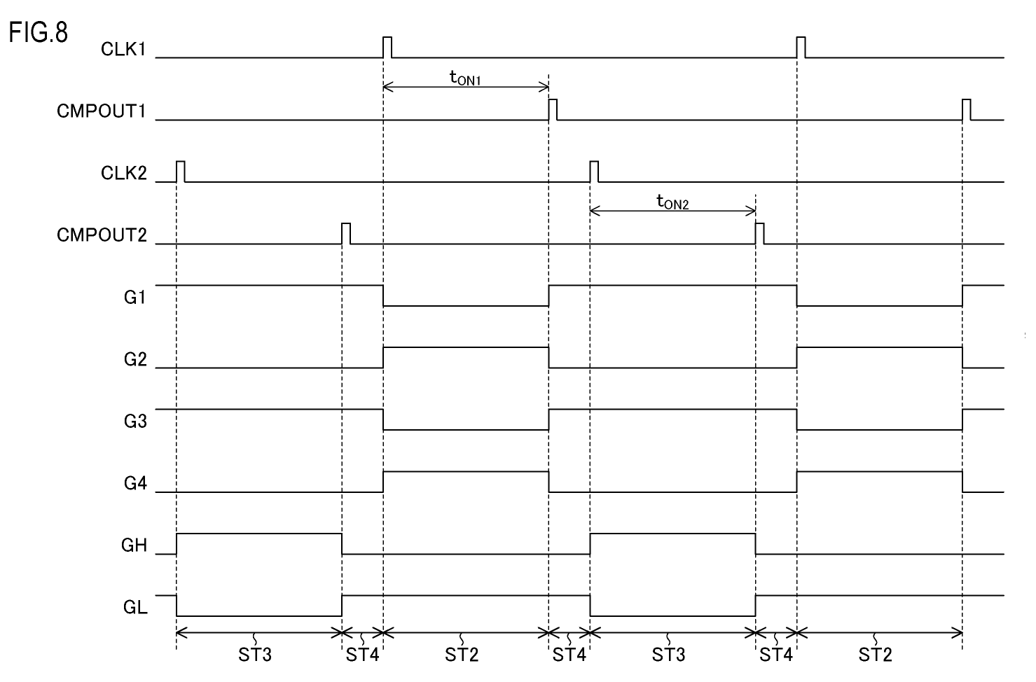

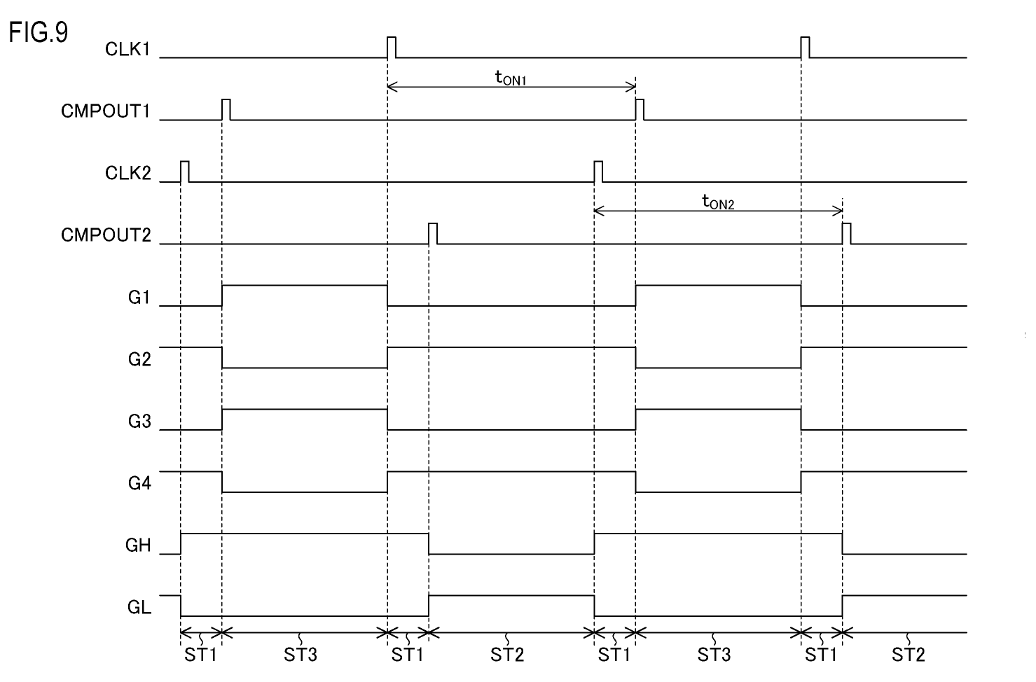

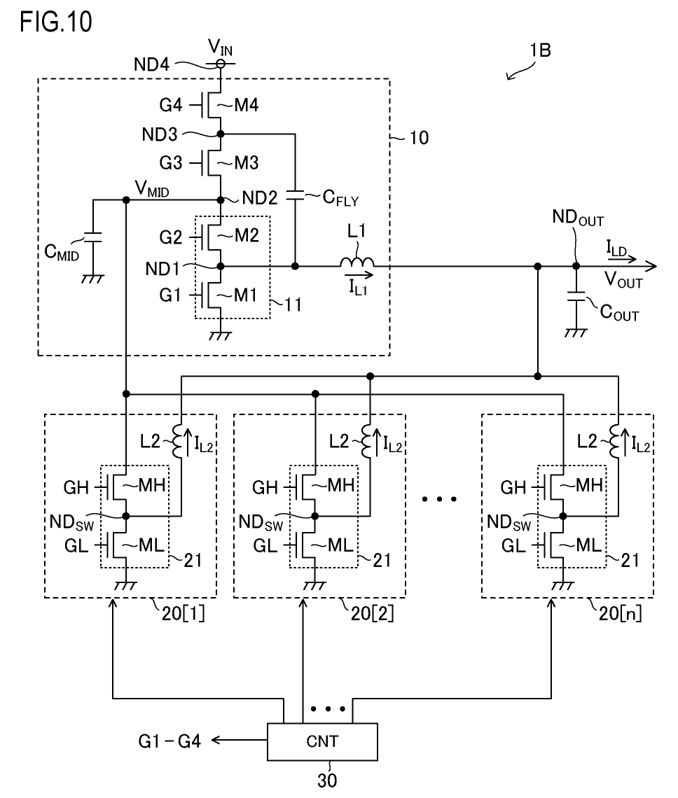

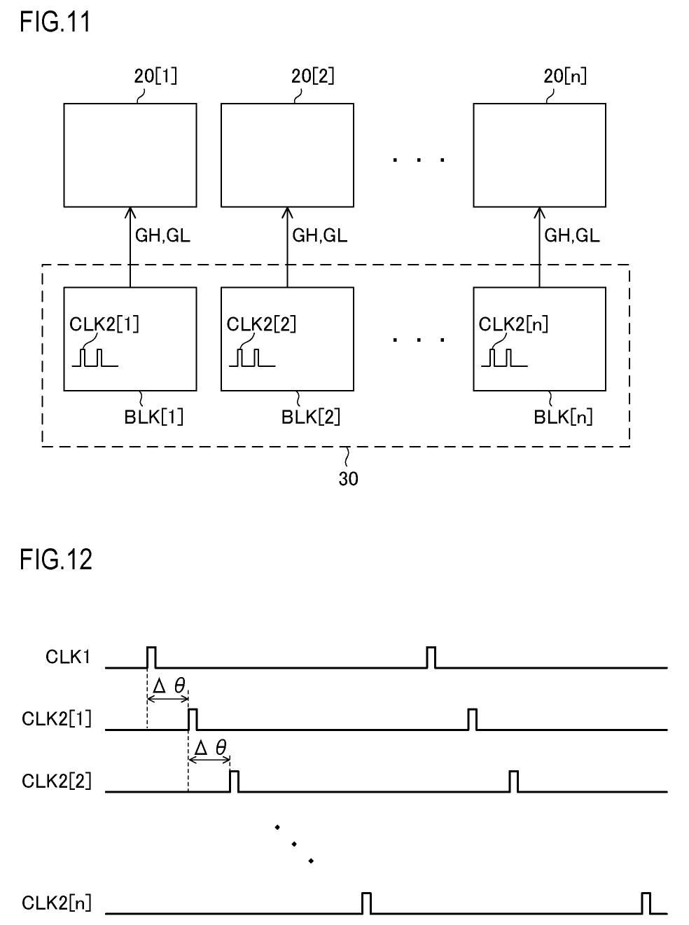

### BRIEF DESCRIPTION OF DRAWINGS

[FIG. 1] FIG. 1 is a diagram showing a configuration of a power supply device according to a first embodiment of the present disclosure.

[FIG. 2] FIG. 2 is a diagram illustrating the operation of a hybrid buck converter in the power supply device according to the first embodiment of the present disclosure.

[FIG. 3] FIG. 3 is a diagram illustrating the operation of the power supply device according to the first embodiment of the present disclosure (state ST1).

[FIG. 4] FIG. 4 is a diagram illustrating the operation of the power supply device according to the first embodiment of the present disclosure (state ST2).

[FIG. 5] FIG. 5 is a diagram illustrating the operation of the power supply device according to the first embodiment of the present disclosure (state ST3).

[FIG. 6] FIG. 6 is a diagram illustrating the operation of the power supply device according to the first embodiment of the present disclosure (state ST4).

[FIG. 7] FIG. 7 is a diagram showing the internal configuration of a control circuit according to the first embodiment of the present disclosure.

[FIG. 8] FIG. 8 is a first example of a timing chart of the power supply device according to the first embodiment of the present disclosure.

[FIG. 9] FIG. 9 is a second example of a timing chart of the power supply device according to the first embodiment of the present disclosure.

[FIG. 10] FIG. 10 is a diagram showing the configuration of a power supply device according to a second embodiment of the present disclosure.

[FIG. 11] FIG. 11 is a diagram showing the relationship between a control circuit and a plurality of converters according to the second embodiment of the present disclosure.

[FIG. 12] FIG. 12 is a diagram showing the relationship among a plurality of clock signals in the power supply device according to the second embodiment of the present disclosure.

### DESCRIPTION OF EMBODIMENTS

Examples of implementing the present disclosure will be specifically described below with reference to the accompanying drawings. Among the diagrams referred to in the course, the same parts are identified by the same reference signs, and in principle no overlapping description of the same parts will be repeated. In the present description, for the sake of simplicity, symbols and reference signs referring to information, signals, physical quantities, functional blocks, circuits, elements, components, and the like are occasionally used with omission or abbreviation of the names of the information, signals, physical quantities, functional blocks, circuits, elements, components, and the like corresponding to those symbols and reference signs.

First, some of the terms used to describe embodiments of the present disclosure will be defined. “Ground” denotes a reference conductor at a reference potential of 0 V (zero volts), or to a reference potential of 0 V itself. A given component, electrode, or node being connected to a ground denotes that the component, electrode, or node is connected to a reference node at a reference potential of 0 V. A reference node can be read as a ground and vice versa.

“Level” denotes the level of a potential, and for any signal or voltage of interest, “high level” is a potential higher than “low level.” For any signal or voltage of interest, its being at high level means, more precisely, its level being equal to high level, and its being at low level means, more precisely, its level being equal to low level. For any signal or voltage of interest, a switch from low level to high level is referred to as a rise edge, and a switch from high level to low level is referred to as a fall edge.

Any switching elements can be configured as a transistor. For any transistor configured as an FET (field-effect transistor), which can be a MOSFET, “on state” refers to a state where the transistor is conducting between its drain and source, and “off state” refers to a state where the transistor is not conducting (is cut off) between its drain and source. The same applies to any transistor that is not classified as an FET. Unless otherwise stated, any MOSFET can be understood to be an enhancement MOSFET. “MOSFET” is an abbreviation of “metal-oxide-semiconductor field-effect transistor.” Unless otherwise stated, for any MOSFET, its back gate can be understood to be short-circuited to its source.

In the following description, for any switching element, its being in on or off state is occasionally referred to as its being on or off respectively. For any switching element, a switch from off state to on state is referred to as a turn-on, and a switch from on state to off state is referred to as a turn-off. For any switching element, a period in which it is in on state is often referred to as an on period, and a period in which it is in off state is often referred to as an off period.

For any signal that takes as its signal level high level or low level, a period in which the signal is at high level is referred to as a high-level period and a period in which the signal is at low level is referred to as a low-level period. The same applies to any voltage that takes as its voltage level high level or low level.

Wherever “connection” is discussed among a plurality of parts constituting a circuit, as among any circuit elements, wirings, nodes, and the like, unless otherwise stated, the term is to be understood to denote “electrical connection.”

For any two voltages v1 and v2 to be compared with each other, “v1 > v2” expresses that voltage v1 is higher than voltage v2, and “v1 < v2” expresses that voltage v1 is lower than voltage v2. This applies to any other expressions that include a physical quantity other than voltage.

### First Embodiment

A first embodiment of the present disclosure will be described. FIG. 1 shows a configuration of a power supply device 1A according to the first embodiment of the present disclosure. The power supply device 1A constitutes a two-phase multiphase converter with converters 10 and 20 for two channels.

The power supply device 1A receives a positive input voltage V_{IN} from a voltage source not shown and steps down (bucks) the input voltage V_{IN} to produce a positive output voltage V_{OUT}. The output voltage V_{OUT} is lower than the input voltage V_{IN}. The power supply device 1A stabilizes the output voltage V_{OUT} at a predetermined target voltage. That is, in a steady state, the output voltage V_{OUT} is substantially equal to the target voltage. In the following description, the target voltage is identified by the symbol “V_{TG}.” In the power supply device 1A, an intermediate voltage V_{MID} is generated. The output voltage V_{OUT} is lower than the intermediate voltage V_{MID}. In the steady state, the intermediate voltage V_{MID} is substantially one-half of the input voltage V_{IN}. Thus, “V_{IN} > 2 × V_{OUT}” holds. As long as “V_{IN} > 2 × V_{OUT}” holds, the input voltage V_{IN} and the output voltage V_{OUT} can have any value. In other words, as long as “V_{IN} > 2 × V_{TG}” holds, the input voltage V_{IN} and the target voltage V_{TG} can have any value. For example, the input voltage V_{IN} is 48 V and the target voltage V_{TG} (i.e., the output voltage V_{OUT} in a steady state) is 12 V or 5 V.

Note that, in the power supply device 1A, a steady state means a state where, after the power supply device 1A has started up and the output voltage V_{OUT} has risen from 0 V and reached the target voltage V_{TG}, the output voltage V_{OUT} is being stabilized at the target voltage V_{TG}.

The power supply device 1A includes converters 10 and 20 and a control circuit 30. The converter 10 functions as a reference converter and the converter 20 functions as an additional converter (a converter added to the reference converter). In the power supply device 1A, the converters 10 and 20 each feed an electric current to an output node ND_{OUT} and this produces the output voltage V_{OUT} with a predetermined voltage value at the output node ND_{OUT}.

As components of the converters 10 and 20, the power supply device 1A includes switching elements M1 to M4, ML, and MH, capacitors C_{FLY}, C_{MID}, and C_{OUT}, and inductors L1 and L2. The capacitor C_{FLY} can be referred to as a flying capacitor. The capacitor C_{MID} can be referred to as an intermediate capacitor. The capacitor C_{OUT} can be referred to as an output capacitor.

The converter 10 is a converter of a first channel. The converter 10 includes as its components switching elements M1 to M4, capacitors C_{FLY} and C_{MID}, and an inductor L1. The converter 20 is a converter of a second channel. The converter 20 includes as its components switching elements MH and ML and an inductor L2. The capacitor C_{OUT} is shared by the converters 10 and 20. That is, the capacitor C_{OUT} is a component of each of the converters 10 and 20 and is used by both the converters 10 and 20.

The converter 10 has a buck converter and a stacked converter. The buck converter in the converter 10 includes switching elements M1 and M2 and an inductor L1, and, together with the capacitor C_{OUT}, steps down the intermediate voltage V_{MID} to produce the output voltage V_{OUT} at the output node ND_{OUT}. The switching elements M1 and M2 respectively function as a low-side and a high-side switching element in the buck converter in the converter 10.

The stacked converter in the converter 10 includes switching elements M3 and M4 and a capacitor C_{FLY} and produces the intermediate voltage V_{MID} from the input voltage V_{IN}. The capacitor C_{MID} can be understood to be one component of the stacked converter.

The converter 20 is the buck converter itself. The converter 20, together with the capacitor C_{OUT}, steps down the intermediate voltage V_{MID} to produce the output voltage V_{OUT} at the output node ND_{OUT}. The switching elements ML and MH respectively function as a low-side and a high-side switching element in the converter 20.

The configuration of the power supply device 1A in FIG. 1 will be described in more detail. In the embodiment, the switching elements M1 to M4, ML, and MH are all configured as n-channel MOSFETs. Thus, in the following description, the switching elements M1 to M4, ML, and MH are occasionally referred to as transistors M1 to M4, ML, and MH.

The transistors M1 to M4 are connected in series between a ground and a node ND4. The transistor M1 is provided between the ground and a node ND1, the transistor M2 is provided between nodes ND1 and ND2, the transistor M3 is provided between nodes ND2 and ND3, and the transistor M4 is provided between the nodes ND3 and ND4. More specifically, the source of the transistor M1 is connected to the ground. The drain of the transistor M1 and the source of the transistor M2 are connected to the node ND1. The drain of the transistor M2 and the source of the transistor M3 are connected to the node ND2. The drain of the transistor M3 and the source of the transistor M4 are connected to the node ND3. The drain of the transistor M4 is connected to the node ND4. The node ND4 is a supply power node for receiving the input voltage V_{IN}. That is, the node ND4 is fed with the input voltage V_{IN}. The signals fed to the gates of the transistors M1 to M4 are referred to as gate signals G1 to G4, respectively.

The capacitor C_{FLY} is provided between the nodes ND3 and ND1. That is, the first terminal of the capacitor C_{FLY} is connected to the node ND3 and the second terminal of the capacitor C_{FLY} is connected to the node ND1.

The capacitor C_{MID} is provided between the node ND2 and the ground. That is, the first terminal of the capacitor C_{MID} is connected to the node ND2 and the second terminal of the capacitor C_{MID} is connected to the ground. The first terminal of the capacitor C_{MID} corresponds to the positive terminal of the capacitor C_{MID}. That is, electric charge corresponding to the intermediate voltage V_{MID} is stored in the capacitor C_{MID}.

The inductor L1 is provided between the node ND1 and the output node ND_{OUT}. That is, the first terminal of the inductor L1 is connected to the node ND1 and the second terminal of the inductor L1 is connected to the output node ND_{OUT}.

The capacitor C_{OUT} is provided between the output node ND_{OUT} and the ground. That is, the first terminal of the capacitor C_{OUT} is connected to the output node ND_{OUT} and the second terminal of the capacitor C_{OUT} is connected to the ground. The first terminal of the capacitor C_{OUT} corresponds to the positive terminal of the capacitor C_{OUT}. The voltage at the output node ND_{OUT} is the output voltage V_{OUT}. That is, electric charge corresponding to the output voltage V_{OUT} is stored in the capacitor C_{OUT}.

The transistor MH is provided between the node ND2 and a node ND_{SW} and the transistor ML is provided between the node ND_{SW} and the ground. More specifically, the source of the transistor ML is connected to the ground. The drain of the transistor ML and the source of the transistor MH are connected to the node ND_{SW} (switching node). The drain of the transistor MH is connected to the node ND2. The signals fed to the gates of the transistors ML and MH are referred to as gate signals GL and GH, respectively.

The inductor L2 is provided between the node ND_{SW} and the output node ND_{OUT}. That is, the first terminal of the inductor L2 is connected to the node ND_{SW} and the second terminal of the inductor L2 is connected to the output node ND_{OUT}.

The control circuit 30 is connected to all the gates of the transistors M1 to M4, ML, and MH; it feeds the gate signals G1 to G4, GL, and GH to the transistors M1 to M4, ML, and MH and thereby individually controls the states (on/off states) of the transistors M1 to M4, ML, and MH. As a result of the control circuit 30 controlling the states of the transistors M1 to M4, ML, and MH, a desired output voltage V_{OUT} that is lower than the input voltage V_{IN} is produced at the output node ND_{OUT}. The control circuit 30 can be formed with a semiconductor integrated circuit.

Let any of the gate signals G1 to G4, GL, and GH be referred to as the gate signal Gx. Among the transistors M1 to M4, ML, and MH, let any of them that receives the gate signal Gx at its gate be referred to as the transistor Mx. When the gate signal Gx is at high level, the transistor Mx is in on state and when the gate signal Gx is at low level, the transistor Mx is in off state. Thus, during a high-level period of the gate signal G1, the transistor M1 is in on state and, during a low-level period of the gate signal G1, the transistor M1 is in off state. Likewise, during the high-level period of the gate signal G2, the transistor M2 is in on state and, during the low-level period of the gate signal G2, the transistor M2 is in off state. The same applies to the transistors M3, M4, ML, and MH. The gate signal Gx at high level has much higher potential than a potential that is higher than the source potential of the transistor Mx by the gate threshold voltage of the transistor Mx. The gate signal Gx at low level can have a potential that is similar to the source potential of the transistor Mx.

The transistors M1 and M2 constitute a switching output stage 11 in the converter 10. The transistors ML and MH constitute a switching output stage 21 in the converter 20. The switching output stages 11 and 21 are each connected to the node ND2 and, under the control of the control circuit 30, steps down the intermediate voltage V_{MID}.

The control circuit 30 performs, for the switching output stage 11, switching control to turn on and off the transistors M1 and M2 alternately so as to make the converter 10 step down of the intermediate voltage V_{MID}. Separately from that, the control circuit 30 performs, for the switching output stage 21, switching control to turn on and off the transistors ML and MH alternately so as to make the converter 20 step down the intermediate voltage V_{MID}. In the power supply device 1A, the stepping down of the intermediate voltage V_{MID} by the converter 10 and the stepping down of the intermediate voltage V_{MID} by the converter 20 produce the output voltage V_{OUT} at the output node ND_{OUT}.

The output node ND_{OUT} is connected to a load not shown. The load can be any load that is driven based on the output voltage V_{OUT}. The electric current fed from the output node ND_{OUT} to the load is referred to as the load current I_{LD}. The load current I_{LD} corresponds to the output current of the power supply device 1A. The electric current passing through the inductor L1 is referred to as the inductor current I_{L1} and the electric current passing through the inductor L2 is referred to as the inductor current I_{L2}. Here, the power supply device 1A is assumed to be operating in a continuous current mode. In the continuous current mode, a current passes all the time from the first terminal to the second terminal of each of the inductors L1 and L2. That is, a current passes all the time through the inductors L1 and L2 in such a direction as to charge the capacitor C_{OUT}.

With reference to FIG. 2, the operation of the converter 10 will be further described. Note that a current in such a direction as to increase the potential at the first terminal of the capacitor C_{FLY} (i.e., the potential at the node ND3) relative to the potential at the second terminal of the capacitor C_{FLY} (i.e., the potential at the node ND1) is a charge current for the capacitor C_{FLY} and a current in the opposite direction is a discharge current for the capacitor C_{FLY}. For the capacitor C_{MID}, a current in such a direction as to increase the intermediate voltage V_{MID} is a charge current and a current in such a direction as to decrease the intermediate voltage V_{MID} is a discharge current.

The control circuit 30 switches the states of the transistors M1 to M4 alternately between states STa and STb. In the state STa, the transistors M1 and M3 are in off state and the transistors M2 and M4 are in on state. In the state STb, the transistors M1 and M3 are in on state and the transistors M2 and M4 are in off state.

In the state STa, currents 811 and 813 are generated. The current 811 is a current that passes from the capacitor C_{MID} via the transistor M2 and the inductor L1 toward the output node ND_{OUT} and is generated as the capacitor C_{MID} is discharged. The current 813 is a current that passes from the node ND4, which is an application terminal for the input voltage V_{IN}, via the transistor M4 toward the capacitor C_{FLY} and the capacitor C_{FLY} is charged with the current 813.

In the state STb, currents 812 and 814 are generated. The current 812 passes from the ground via the transistor M1 and the inductor L1 toward the output node ND_{OUT}. The current 814 is a current that passes from the capacitor C_{FLY} via the transistor M3 toward the positive terminal of the capacitor C_{MID}. The current 814 is generated as the capacitor C_{FLY} is discharged, and contributes to the charging of the capacitor C_{MID}.

Since the transistors M2 and M4 are on in the state STa, for the capacitors C_{FLY} and C_{MID}, the state STa is equivalent to a state where the capacitors C_{FLY} and C_{MID} are connected in series. On the other hand, in the state STb, through the transistors M1 and M3, the capacitors C_{FLY} and C_{MID} are connected in parallel. As a result, the transistors M1 to M4 and the capacitors C_{FLY} and C_{MID} constitute a switched capacitor circuit. Thus, the intermediate voltage V_{MID}, which is a voltage at the positive terminal of the capacitor C_{MID} in the steady state, is approximately equal to the voltage V_{IN}/2. That is, the converter 10 produces the intermediate voltage V_{MID} corresponding to a division voltage of the input voltage V_{IN}.

On the other hand, the transistors M1 and M2 and inductor L1 constitute a synchronous buck converter that steps down the intermediate voltage V_{MID}. Thus, the converter 10 can be called a hybrid buck converter having a switched capacitor circuit and a synchronous buck converter combined together.

With the switched capacitor circuit, the input voltage V_{IN} can be reduced to one half and, with the synchronous buck converter, the obtained intermediate voltage V_{MID} can be further stepped down. This leads to high efficiency.

For example, consider a case where an output voltage V_{OUT} of 12 V is produced from an input voltage V_{IN} of 48 V. By a standard method, 48 V is directly stepped down to 12 V with a simple synchronous buck converter. By the standard method, an input voltage V_{IN} of 48 V is subjected to switching to produce a rectangular wave voltage (a rectangular wave voltage that alternates between approximately 0 V and 48 V) and the rectangular wave voltage is rectified and smoothed to obtain an output voltage of 12 V. In contrast, in the power supply device 1A, the voltage V_{IN}/2 is subjected to switching to produce a rectangular wave voltage (a rectangular wave voltage that alternates between approximately 0 V and 24 V) and the rectangular wave voltage is rectified and smoothed to obtain an output voltage of 12 V. Thus, as compared with a power supply device employing the standard method, the power supply device 1A operates with low switching loss.

The low switching loss results from several factors, of which some will be described below as examples. With the standard method, the duty of switching is relatively low. A relatively small duty of switching makes relatively large the impact of a loss during periods in which the instantaneous value of the rectangular wave voltage rises or falls. In contrast, with the power supply device 1A, since the input voltage to the synchronous buck converter is the voltage V_{IN}/2, as compared with the standard method, the duty of switching is relatively high. This leads to reduced switching loss. In addition, in the process of switching, various parasitic capacitances are charged and discharged; in the power supply device 1A, since the input voltage to the synchronous buck converter is the voltage V_{IN}/2, the loss resulting from the charging and discharging of parasitic capacitances can be suppressed to be relatively low as compared with the standard method.

Further, the power supply device 1A is provided with, separately from the synchronous buck converter in the hybrid buck converter (10), a synchronous buck converter (20) that steps down the intermediate voltage V_{MID}, and makes these operate in a multiphase fashion to achieve high output electric power and low output ripples. Even with a reference method that makes a plurality of hybrid buck converters operate in a multiphase fashion, it is possible to obtain high output electric power and low output ripples. This reference method, however, requires as many more components as the number of hybrid buck converters. The power supply device 1A also helps reduce the number of components as compared with the reference method.

While the states of the transistors M1 to M4 are switched between the states STa and STb, the states of the transistors ML and MH are switched between a state where the transistor ML is on and the transistor MH is off and a state where the transistor ML is off and the transistor MH is on. Thus, the states of the transistors M1 to M4, ML, and MH are one of the states ST1 to ST4 shown in FIGS. 3 to 6 at a given time.

The control circuit 30 can set the states of the transistors M1 to M4, ML, and MH to one of the states ST1 to ST4.

In the state ST1 shown in FIG. 3, the transistors M1, M3, and ML are off and the transistors M2, M4, and MH are on. In the state ST1, the states of the transistors M1 to M4 are the state STa (see FIG. 2). Thus, in the state ST1, in the converter 10, the currents 811 and 813 described above are generated. On the other hand, in the state ST1, in the converter 20, a current 821 is generated. The current 821 is a current that passes from the capacitor C_{MID} via the transistor MH and the inductor L2 toward the output node ND_{OUT} and is generated as the capacitor C_{MID} is discharged.

In the state ST2 shown in FIG. 4, the transistors M1, M3, and MH are off and the transistors M2, M4, and ML are on. In the state ST2, the states of the transistors M1 to M4 are the state STa (see FIG. 2). Thus, in the state ST2, in the converter 10, the currents 811 and 813 described above are generated. On the other hand, in the state ST2, in the converter 20, a current 822 is generated. The current 822 passes from the grand via the transistor ML and the inductor L2 toward the output node ND_{OUT}.

In the state ST3 shown in FIG. 5, the transistors M2, M4, and ML are off and the transistors M1, M3, and MH are on. In the state ST3, the states of the transistors M1 to M4 are the state STb (see FIG. 2). Thus, in the state ST3, in the converter 10, the currents 812 and 814 described above are generated. On the other hand, in the state ST3, in the converter 20, the current 821 described above is generated.

In the state ST4 shown in FIG. 6, the transistors M2, M4, and MH are off and the transistors M1, M3, and ML are on. In the state ST4, the states of the transistors M1 to M4 are the state STb (see FIG. 2). Thus, in the state ST4, in the converter 10, the currents 812 and 814 described above are generated. On the other hand, in the state ST4, in the converter 20, the current 822 described above is generated.

FIG. 7 shows the internal configuration of the control circuit 30. FIGS. 8 and 9 show timing charts of a first and a second operation example of the control circuit 30. FIGS. 8 and 9 each depict, from top down, the wave forms of signals CLK1, CMPOUT1, CLK2, CMPOUT2, G1 to G4, and GH and GL.

The control circuit 30 includes an error amplifier 31, ramp circuits 32_1 and 32_2, current information acquisition circuits 33_1 and 33_2, adders 34_1 and 34_2, PWM comparators 35_1 and 35_2, and controllers 36_1 and 36_2. Note that the power supply device 1A is provided with resistors R1 and R2. The first terminal of the resistor R1 is connected to the output node ND_{OUT}, the second terminal of the resistor R1 is connected to the first terminal of the resistor R2, and the second terminal of the resistor R2 is connected to the ground. At the connection node between the resistors R1 and R2, a feedback voltage V_{FB} corresponding to the output voltage V_{OUT} is generated. The feedback voltage V_{FB} is a division voltage of the output voltage V_{OUT} and thus it is proportional to the output voltage V_{OUT}. The resistors R1 and R2 constitute a feedback voltage generation circuit that produces a feedback voltage V_{FB}. The feedback voltage V_{FB} is fed to the control circuit 30. Note that the feedback voltage generation circuit can be understood to be one component of the control circuit 30. The output voltage V_{OUT} itself can be used as the feedback voltage V_{FB}. In any case, the feedback voltage V_{FB} conveys information on the output voltage V_{OUT} (specifically, information on the value of the output voltage V_{OUT}).

The error amplifier 31 is a transconductance amplifier of a current-output type. The error amplifier 31 includes an inverting input terminal, a non-inverting input terminal, and an output terminal. The inverting input terminal of the error amplifier 31 is fed with the feedback voltage V_{FB}. The non-inverting input terminal of the error amplifier 31 is fed with a predetermined reference voltage V_{REF}. The reference voltage V_{REF} is a direct current voltage with a predetermined positive voltage value and is generated in a reference voltage generation circuit, not shown, in the control circuit 30. The output terminal of the error amplifier 31 is connected to a wire WR_{ERR}. Note that, when the power supply device 1A is started up, soft-start control can be performed to gradually raise the value of the reference voltage V_{REF} from 0 V toward the predetermined positive voltage value. In the following description, however, the soft start control is ignored.

The error amplifier 31 outputs from its output terminal a current signal corresponding to the difference between the feedback voltage V_{FB} and the reference voltage V_{REF}, and thereby produces at the wire WR_{ERR} an error voltage V_{ERR} corresponding to the difference between the feedback voltage V_{FB} and the reference voltage V_{REF}. Specifically, when the feedback voltage V_{FB} is lower than the reference voltage V_{REF}, the error amplifier 31 outputs a current from its output terminal toward the wire WR_{ERR} so as to raise the error voltage V_{ERR} and when the feedback voltage V_{FB} is higher than the reference voltage V_{REF}, it draws a current from the wire WR_{ERR} into its output terminal so as to lower the error voltage V_{ERR}. Note that, though not specifically shown, a phase compensation circuit including a capacitor can be connected between the wire WR_{ERR} and the ground.

The ramp circuit 32_1 produces a ramp voltage V_{RAMP1} that monotonously rises at a predetermined changing rate from a predetermined initial voltage V_{INT} in the on period of the transistor M2. In the ramp circuit 32_1, the initial voltage V_{INT} is, for example, 0 V, but it can be different from 0 V. In the off period of the transistor M2, the ramp voltage V_{RAMP1} is fixed at the initial voltage V_{INT}.

The current information acquisition circuit 33_1 acquires current information on the inductor L1 and produces a sense voltage V_{IL1} that conveys the current information on the inductor L1. The current information on the inductor L1 is information on the value of the inductor current I_{L1}. The sense voltage V_{IL1} has a voltage value that is proportional to the value of the inductor current I_{L1} with a positive proportionality coefficient. Thus, as the inductor current I_{L1} increases, the sense voltage V_{IL1} rises and as the inductor current I_{L1} decreases, the sense voltage V_{IL1} falls. Here, assume V_{IL1} = k_{IV} × I_{L1}, where k_{IV} is a predetermined positive coefficient.

As long as the sense voltage V_{IL1} conveys the current information on the inductor L1, the sense voltage V_{IL1} can be produced in any way. For example, a current sensor can be used to directly sense the inductor current I_{L1} to produce the sense voltage V_{IL1}. In such a case, the current sensor can be a shunt resistor (not shown) inserted in series between the inductor L1 and the node ND1. Or, for example, the current passing through the transistor M2 in the on period of the transistor M2 (hence the inductor current I_{L1}), or the current passing through the transistor M1 in the on period of the transistor M1 (hence the inductor current I_{L1}) can be sensed to produce the sense voltage V_{IL1}. Or, a voltage at any point at which a voltage corresponding to the inductor current I_{L1} appears can be sensed to produce the sense voltage V_{IL1}.

The adder 34_1 adds the sense voltage V_{IL1} to the ramp voltage V_{RAMP1} and thereby produces a slope voltage V_{SLP1} as their sum voltage. Thus, V_{SLP1} = V_{RAMP1} + V_{IL1}.

The PWM comparator 35_1 compares the error voltage V_{ERR} with the slope voltage V_{SLP1} and produces and outputs a signal CMPOUT1 indicating the result of their comparison. The inverting input terminal of the PWM comparator 35_1 is fed with the error voltage V_{ERR} and the non-inverting input terminal of the PWM comparator 35_1 is fed with the slope voltage V_{SLP1}. If V_{SLP1} < V_{ERR} holds, the PWM comparator 35_1 outputs the signal CMPOUT1 at low level and, if V_{SLP1} > V_{ERR} holds, the PWM comparator 35_1 outputs the signal CMPOUT1 at high level. If V_{SLP1} = V_{ERR} holds, the signal CMPOUT1 is at either low level or high level.

The controller 36_1 is fed with the signal CMPOUT1 and a reference clock signal CLK1. The reference clock signal CLK1 is generated in an internal clock producing circuit, not shown, provided in the control circuit 30. The reference clock signal CLK1 is a rectangular wave signal with a predetermined frequency f_{PWM} and its signal level alternates between high level and low level. The reference clock signal CLK1 can have any duty. Here, the reference clock signal CLK1 is assumed to be in principle at low level and at high level only for a minute period at intervals equal to the reciprocal of the frequency f_{PWM} (see FIGS. 8 and 9).

Triggered by a predetermined level change of the reference clock signal CLK1, the controller 36_1 generates a rise edge in the gate signals G2 and G4 (i.e., switches the levels of the gate signals G2 and G4 from low level to high level) to turn on the transistors M2 and M4 and generates a fall edge in the gate signals G1 and G3 (i.e., switches the levels of the gate signals G1 and G3 from high level to low level) to turn off the transistors M1 and M3. Here, the predetermined level change (first predetermined level change) of the reference clock signal CLK1 is a change of the reference clock signal CLK1 from low level to high level, but it can be a change of the reference clock signal CLK1 from high level to low level.

After the turn-on of the transistors M2 and M4 and the turn-off of the transistors M1 and M3, as the slope voltage V_{SLP1} monotonously rises, a transition is made from the state where V_{SLP1} < V_{ERR} holds to the state where V_{SLP1} > V_{ERR} holds. This produces a rise edge in the signal CMPOUT1. In response to the rise edge in the signal CMPOUT1, the controller 36_1 generates a fall edge in the gate signals G2 and G4 to turn off the transistors M2 and M4 and generates a rise edge in the gate signals G1 and G3 to turn on the transistors M1 and M3. With the transistor M2 turned off, the ramp voltage V_{RAMP1} falls to the initial voltage V_{INT}, which is sufficiently low, so that a return is made to the state where V_{SLP1} < V_{ERR} holds and this promptly produces a fall edge in the signal CMPOUT1. Note that the period from when the transistors M2 and M4 are turned on and the transistors M1 and M3 are turned off to when the transistors M2 and M4 are turned off and the transistors M1 and M3 are turned on is referred to as a time t_{ON1}.

The ramp circuit 32_2 produces a ramp voltage V_{RAMP2} that monotonously rises from the predetermined initial voltage V_{INT} at a predetermined changing rate in the on period of the transistor MH. In the ramp circuit 32_2, the initial voltage V_{INT} is, for example, 0 V, but it can be different from 0 V. In the off period of the transistor MH, the ramp voltage V_{RAMP2} is fixed at the initial voltage V_{INT}. Note that the ramp circuit 32_2 has the same configuration as the ramp circuit 32_1. Thus, the changing rate of the ramp voltage V_{RAMP2} in the on period of the transistor MH is equal to the changing rate of the ramp voltage V_{RAMP1} in the on period of the transistor M2.

The current information acquisition circuit 33_2 acquires current information on the inductor L2 and produces a sense voltage V_{IL2} that conveys the current information on the inductor L2. The current information on the inductor L2 is information on the value of the inductor current I_{L2}. The sense voltage V_{IL2} has a voltage value that is proportional to the value of the inductor current I_{L2} with a positive proportionality coefficient. Thus, as the inductor current I_{L2} increases, the sense voltage V_{IL2} rises and as the inductor current I_{L2} decreases, the sense voltage V_{IL2} falls. Here, assume V_{IL2} = k_{IV} × I_{L2}.

As long as the sense voltage V_{IL2} conveys the current information on the inductor L2, the sense voltage V_{IL2} can be produced in any way. For example, a current sensor can be used to directly sense the inductor current I_{L2} to produce the sense voltage V_{IL2}. In such a case, the current sensor can be a shunt resistor (not shown) inserted in series between the inductor L2 and the node ND_{SW}. Or, for example, the current passing through the transistor MH in the on period of the transistor MH (hence the inductor current I_{L2}), or the current passing through the transistor ML in the on period of the transistor ML (hence the inductor current I_{L2}) can be sensed to produce the sense voltage V_{IL2}. Or, a voltage at any point at which a voltage corresponding to the inductor current I_{L2} appears can be sensed to produce the sense voltage V_{IL2}.

The adder 34_2 adds the sense voltage V_{IL2} to the ramp voltage V_{RAMP2} and thereby produces a slope voltage V_{SLP2} as their sum voltage. Thus, V_{SLP2} = V_{RAMP2} + V_{IL2}.

The PWM comparator 35_2 compares the error voltage V_{ERR} with the slope voltage V_{SLP2} and produces and outputs a signal CMPOUT2 indicating the result of their comparison. The inverting input terminal of the PWM comparator 35_2 is fed with the error voltage V_{ERR} and the non-inverting input terminal of the PWM comparator 35_2 is fed with the slope voltage V_{SLP2}. If V_{SLP2} < V_{ERR} holds, the PWM comparator 35_2 outputs the signal CMPOUT2 at low level and, if V_{SLP2} > V_{ERR} holds, the PWM comparator 35_2 outputs the signal CMPOUT2 at high level. If V_{SLP2} = V_{ERR} holds, the signal CMPOUT2 is at either low level or high level.

The controller 36_2 is fed with the signal CMPOUT2 and a shifted clock signal CLK2. The shifted clock signal CLK2 is a signal obtained by shifting the phase of the reference clock signal CLK1. Thus, the reference clock signal CLK1 and the shifted clock signal CLK2 have the same frequency f_{PWM} but have different phases. Like the reference clock signal CLK1, the shifted clock signal CLK2 is in principle at low level and at high level only for a minute period at intervals equal to the reciprocal of the frequency f_{PWM} (see FIGS. 8 and 9). The shifted clock signal CLK2 can be produced in the control circuit 30 based on the reference clock signal CLK1. Here, the shifted clock signal CLK2 is assumed to be a signal with a phase delayed by 180° from the reference clock signal CLK1. Thus, the phase difference between the clock signals CLK1 and CLK2 is 180°. Setting the delay to 180° optimally minimizes ripples in the output voltage V_{OUT}. Note that the delay of the phase of the shifted clock signal CLK2 relative to the phase of the reference clock signal CLK1 can be other than 180° (e.g., 170° or 190°).

Triggered by a predetermined level change of the shifted clock signal CLK2, the controller 36_2 generates a rise edge in the gate signal GH to turn on the transistor MH and generates a fall edge in the gate signal GL to turn off the transistor ML. Here, the predetermined level change (second predetermined level change) of the shifted clock signal CLK2 is a change of the shifted clock signal CLK2 from low level to high level, but it can be a change of the shifted clock signal CLK2 from high level to low level.

After the turn-on of the transistor MH and the turn-off of the transistor ML, as the slope voltage V_{SLP2} monotonously rises, a transition is made from the state where V_{SLP2} < V_{ERR} holds to the state where V_{SLP2} > V_{ERR} holds. This produces a rise edge in the signal CMPOUT2. In response to the rise edge in the signal CMPOUT2, the controller 36_2 generates a fall edge in the gate signal GH to turn off the transistor MH and generates a rise edge in the gate signal GL to turn on the transistor ML. With the transistor MH turned off, the ramp voltage V_{RAMP2} falls to the initial voltage V_{INT}, which is sufficiently low, so that a return is made to the state where V_{SLP2} < V_{ERR} holds and this promptly produces a fall edge in the signal CMPOUT2. Note that the period from when the transistor MH is turned on and the transistor ML is turned off to when the transistor MH is turned off and the transistor ML is turned on is referred to as a time t_{ON2}.

Through the above-described switching control by the controllers 36_1 and 36_2, the states of the transistors M1 to M4, ML, and MH are switched among the states ST1 to ST4 as shown in FIGS. 8 and 9.

In the timing chart in FIG. 8, the on duties of the transistors M2 and MH are both lower than 50%. On the other hand, in the timing chart in FIG. 9, the on duties of the transistors M2 and MH are both higher than 50%. The on duty of the transistor M2 means the proportion of the on period of the transistor M2 to the sum of the on and off periods of the transistor M2. Likewise, the on duty of the transistor MH means the proportion of the on period of the transistor MH to the sum of the on and off periods of the transistor MH. Depending on various operation conditions related to the output voltage V_{OUT} (the on duty and the times t_{ON1} and t_{ON2} mentioned above), operation proceeds either as shown in FIG. 8 or as shown in FIG. 9.

In the timing chart in FIG. 8, the state immediately before a rise edge in the reference clock signal CLK1 is the state ST4. In the timing chart in FIG. 8, the state ST4 immediately before a rise edge in the reference clock signal CLK1 is taken as the initial state. In the timing chart in FIG. 8, the states of the transistors M1 to M4, ML, and MH are switched as follows: triggered by a rise edge in the reference clock signal CLK1, from the state ST4 as the initial state to the state ST2; then, triggered by a rise edge in the signal CMPOUT1, from the state ST2 to the state ST4; then, triggered by a rise edge in the shifted clock signal CLK2, from the state ST4 to the state ST3; and then, triggered by a rise edge in the signal CMPOUT2, from the state ST3 back to the state ST4 as the initial state. Subsequently, similar operation is repeated.

In the timing chart in FIG. 9, the state immediately before a rise edge in the reference clock signal CLK1 is the state ST3. In the timing chart in FIG. 9, the state ST3 immediately before a rise edge in the reference clock signal CLK1 is taken as the initial state. In the timing chart in FIG. 9, the states of the transistors M1 to M4, ML, and MH are switched as follows: triggered by a rise edge in the reference clock signal CLK1, from the state ST3 as the initial state to the state ST1; then, triggered by a rise edge in the signal CMPOUT2, from the state ST1 to the state ST2; then, triggered by a rise edge in the shifted clock signal CLK2, from the state ST2 to the state ST1; and then, triggered by a rise edge in the signal CMPOUT1, from the state ST1 back to the state ST3 as the initial state. Subsequently, similar operation is repeated.

If V_{OUT} = V_{TG} holds, V_{FB} = V_{REF} holds. Starting in the state where V_{OUT} = V_{TG} holds, when the load current I_{LD} increases until V_{OUT} < V_{TG} holds, V_{FB} < V_{REF} holds, so that the error voltage V_{ERR} rises. The rise of the error voltage V_{ERR} causes an increase in the on periods of the transistors M2 and MH. In response to the increase in the on period of the transistor M2, the inductor current I_{L1} increases and in response to the increase in the on period of the transistor MH, the inductor current I_{L2} increases. As a result, the output voltage V_{OUT} rises toward the target voltage V_{TG}. On the other hand, starting in the state where V_{OUT} = V_{TG} holds, when the load current I_{LD} decreases until V_{OUT} > V_{TG} holds, V_{FB} > V_{REF} holds, so that the error voltage V_{ERR} falls. The fall of the error voltage V_{ERR} causes a decrease in the on periods of the transistors M2 and MH. In response to the decrease in the on period of the transistor M2, the inductor current I_{L1} decreases and in response to the decrease in the on period of the transistor MH, the inductor current I_{L2} decreases. As a result, the output voltage V_{OUT} falls toward the target voltage V_{TG}. In this way, control proceeds so as to lessen the difference between the output voltage V_{OUT} and the target voltage V_{TG}.

The above-mentioned time t_{ON1} depends on the error voltage V_{ERR} (hence depends on the information on the output voltage V_{OUT}) and depends also on the sense voltage V_{IL1} (hence depends on the current information on the inductor L1). That is, based on the information on the output voltage V_{OUT} and the current information on the inductor L1, in synchronization with the reference clock signal CLK1, the controller 36_1 performs switching control on the transistors M1 to M4. Triggered by a predetermined level change of the reference clock signal CLK1, the controller 36_1 turns on the transistors M2 and M4 and turns off the transistors M1 and M3 and, after the lapse of the time t_{ON1} corresponding to the information on the output voltage V_{OUT} and the current information on the inductor L1, turns off the transistors M2 and M4 and turns on the transistors M1 and M3.

The above-mentioned time t_{ON2} depends on the error voltage V_{ERR} (hence depends on the information on the output voltage V_{OUT}) and depends also on the sense voltage V_{IL2} (hence depends on the current information on the inductor L2). That is, based on the information on the output voltage V_{OUT} and the current information on the inductor L2, in synchronization with the shifted clock signal CLK2, the controller 36_2 performs switching control on the transistors ML and MH. Triggered by a predetermined level change of the shifted clock signal CLK2, the controller 36_2 turns on the transistor MH and turns off the transistor ML and, after the lapse of the time t_{ON2} corresponding to the information on the output voltage V_{OUT} and the current information on the inductor L2, turns off the transistor MH and turns on the transistor ML.

The pair of the switching output stage 11 and the inductor L1 in the converter 10 and the pair of the switching output stage 21 and the inductor L2 in the converter 20 have the same configuration. In addition, the switching output stages 11 and 21 steps down the intermediate voltage V_{MID} common to them. Further, the switching control for the transistors M1 and M2 based on the current information on the inductor L1 and the switching control for the transistors ML and MH based on the current information on the inductor L2 are equivalent to each other. Thus, multiphase operation is achieved with the output currents of the converters 10 and 20 kept well-balanced.

In the power supply device 1A, the inductor current I_{L1} corresponds to the output current of the converter 10 and the inductor current I_{L2} corresponds to the output current of the converter 20. Although the instantaneous values of the inductor currents I_{L1} and I_{L2} are different from each other at any time, the average of the inductor current I_{L1} and the average of the inductor current I_{L2} are substantially equal. The output currents of the converters 10 and 20 are both pulsating currents and the two output currents have different phases from each other. That is, the power supply device 1A is a two-phase multiphase converter (a DC/DC converter of a multiphase type).

The circuit configuration in FIG. 7 is merely an example and, as long as the above-described current balance is secured, the configuration of the control circuit 30 allow various modification. For example, a modification can be made such that the adders 34_1 and 34_2 are omitted from the control circuit 30 in FIG. 7 and, instead, the current information on the inductors L1 and L2 is fed back to the error amplifier 31. This modified example is configured such that V_{SLP1} = V_{RAMP1} and V_{SLP2} = V_{RAMP2} hold and that the inverting input terminal of the PWM comparator 35_1 is fed with a voltage (V_{ERR} – V_{IL1}) and the inverting input terminal of the PWM comparator 35_2 is fed with a voltage (V_{ERR} – V_{IL2}). In the PWM comparator 35_1 according to the modified example, if V_{SLP1} = V_{RAMP1} < V_{ERR} – V_{IL1} holds, the signal CMPOUT1 is kept at low level and, if V_{SLP1} = V_{RAMP1} > V_{ERR} – V_{IL1} holds, the signal CMPOUT1 is kept at high level. Likewise, in the PWM comparator 35_2 according to the modified example, if V_{SLP2} = V_{RAMP2} < V_{ERR} – V_{IL2} holds, the signal CMPOUT2 is kept at low level and, if V_{SLP2} = V_{RAMP2} > V_{ERR} – V_{IL2} holds, the signal CMPOUT2 is kept at high level.

### Second Embodiment

A second embodiment of the present disclosure will be described. The second embodiment, and also the third embodiment that will be described later, is an embodiment based on the first embodiment. For features not specifically described for the second and third embodiments, unless inconsistent, their description for the first embodiment applies to the second and third embodiments. Note that, in interpreting the description of the second embodiment, for any features that are inconsistent between the first and second embodiments, their description for the second embodiment can prevail (the same applies to the third embodiment that will be described later). Unless inconsistent, any two or more of the first to third embodiments can be implemented in combination.

FIG. 10 shows the configuration of a power supply device 1B according to a second embodiment of the present disclosure. The power supply device 1B has a converter 10 for one channel and a converter 20 for n channels, which together constitute a multiphase converter of (n + 1) phases. If n = 1, the power supply device 1B is quite the same as the power supply device 1A according to the first embodiment itself. In the following description of the second embodiment, n is an integer of two or more.

Modifying the power supply device 1A in FIG. 1 by adding (n – 1) converters 20 gives the power supply device 1B in FIG. 10. Thus, the power supply device 1B includes the converter 10, the n converters 20, and the control circuit 30. Note that the addition of the converter 20 results in the control circuit 30 of the power supply device 1B controlling the state of, in addition to the transistors M1 to M4, transistors ML and MH in each of the converters 20. In the power supply device 1B, the converter 10 and the n converters 20 each feed a current to the output node ND_{OUT} and thereby produce the output voltage V_{OUT} with a desired voltage value at the output node ND_{OUT}.

The configuration and operation of the converter 10 in the power supply device 1B is as described in connection with the first embodiment. Thus, the converter 10 includes the transistors M1 to M4, the capacitors C_{FLY} and C_{MID}, and the inductor L1. The converter 10 generates the intermediate voltage V_{MID} from the input voltage V_{IN} and, together with the capacitor C_{OUT}, steps down the intermediate voltage V_{MID} to produce the output voltage V_{OUT} at the output node ND_{OUT}.

In the power supply device 1B, the converters 20 for n channels all have the same configuration. The configuration and operation of the individual converter 20 is as described in connection with the first embodiment. Thus, each of the converters 20 includes the transistors ML and MH, and the inductor L2. The converters 20, together with the capacitor C_{OUT}, steps down the intermediate voltage V_{MID} to produce the output voltage V_{OUT} at the output node ND_{OUT}.

In the following description, wherever distinction is needed among the converters 20 for n channels, the converters 20 for n channels are referred to as the converters 20[1] to 20[n] respectively. The converter 10 can be understood to be a converter of the first channel and, in that case, the converters 20[1] to 20[n] are converters of the second to the (n+1)th channels.

The capacitor C_{OUT} is shared by the converters 10 and 20[1] to 20[n]. That is, the capacitor C_{OUT} is a component of each of the converters 10 and 20[1] to 20[n] and is used by all the converters 10 and 20[1] to 20[n].

The drains of the transistors MH in the converters 20[1] to 20[n] are all connected to the same node ND2 and are fed with the intermediate voltage V_{MID}. In each of the converters 20[1] to 20[n], the source of the transistor MH and the drain of the transistor ML are connected to the node ND_{SW} and the source of the transistor ML is connected to the ground. In each of the converters 20[1] to 20[n], the first terminal of the inductor L2 is connected to the node ND_{SW}. The second terminals of the inductors L2 in the converters 20[1] to 20[n] are all connected to the same output node ND_{OUT}.

The control circuit 30 is connected to each of the gates of the transistors M1 to M4 and to each of the gates of the transistors ML and MH in the converters 20[1] to 20[n]. The control circuit 30 feeds the gate signals G1 to G4 to the transistors M1 to M4 to individually control the states (on/off states) of the transistors M1 to M4. In addition, the control circuit 30 feeds the gate signals GL and GH to the gates of the transistors ML and MH in each of the converters 20[1] to 20[n] to individually control the states (on/off states) of the transistors ML and MH. Through the control of the states of the transistors M1 to M4 and the transistors ML and MH by the control circuit 30, a desired output voltage V_{OUT} that is lower than the input voltage V_{IN} is produced at the output node ND_{OUT}.

The control circuit 30 includes the components shown in FIG. 7. That is, the control circuit 30 in the power supply device 1B includes the error amplifier 31, the ramp circuits 32_1 and 32_2, the current information acquisition circuits 33_1 and 33_2, the adders 34_1 and 34_2, the PWM comparators 35_1 and 35_2, and the controllers 36_1 and 36_2. Note that, while the control circuit 30 in the power supply device 1A is provided with, only for one channel, a control block including the ramp circuit 32_2, the current information acquisition circuit 33_2, the adder 34_2, the PWM comparator 35_2, and the controller 36_2, the control circuit 30 in the power supply device 1B is provided with control blocks like that for n channels.

As shown in FIG. 11, the control blocks for n channels provided in the control circuit 30 in the power supply device 1B are referred to as the control blocks BLK[1] to BLK[n]. The operation of each of the control blocks BLK[1] to BLK[n] is similar to that of the control block in the first embodiment.

The control blocks BLK[1] to BLK[n] perform the switching control for the switching output stages 21 of the converters 20[1] to 20[n]. Here, the control block BLK[i] performs switching control for the switching output stage 21 of the converter 20[i]. That is, the control block BLK[i] feeds the gate signals GH and GL to the transistors MH and ML in the converter 20[i]. The symbol i represents a natural number. The switching control for the switching output stage 21 of the converter 20[i] is similar to that for the switching output stage 21 in the first embodiment.

The shifted clock signals CLK2 in the control blocks BLK[1] to BLK[n] are signals obtained by shifting the phase of the reference clock signal CLK1. Thus, the reference clock signal CLK1 and the shifted clock signals CLK2 all have the same frequency f_{PWM} but all have different phases. Here, the control circuit 30 makes different from each other the phase of the shifted clock signal CLK2 in the control block BLK[1], the phase of the shifted clock signal CLK2 in the control block BLK[2], … , and the phase of the shifted clock signal CLK2 in the control block BLK[n].

The shifted clock signal CLK2 in the control block BLK[i] is referred to specifically as the sign “CLK2[i].” As shown in FIG. 12, the control circuit 30 makes different from each other the phases of (n + 1) clock signals, namely the phase of the reference clock signal CLK1 and the shifted clock signals CLK2[1] to CLK2[n].

The shifted clock signal CLK2[1] is a signal obtained by delaying the phase of the reference clock signal CLK1 by a predetermined amount Δθ. The shifted clock signal CLK2[i + 1] is a signal obtained by delaying the phase of the shifted clock signal CLK2[i] by the predetermined amount Δθ. Relative to the reference clock signal CLK1, the delay of the phase of the shifted clock signal CLK2[n] is less than 360°. If n = 3, for example, the predetermined amount Δθ is 90°.

### Third Embodiment

A third embodiment of the present disclosure will be described. The third embodiment deals with modified technologies, applied technologies, supplementary features, and the like that are applicable to the first or second embodiment.

The power supply device 1A or 1B according to the present disclosure is applicable to any device or system that requires a stable direct-current voltage. For example, the power supply device 1A or 1B is applicable to a power system for a data center. Here, for example, the output voltage V_{OUT} of the power supply device 1A or 1B can be 48 V and the power supply device 1A or 1B feeds the output voltage V_{OUT} to a power bus of 48 V. In these days, reduction of the power consumed at data centers is a key challenge and, to tackle this, a transition has been progressing from a power bus of 12 V to a power bus of 48 V. This requires electric power to be supplied with at high efficiency from a power bus of 48 V to a sever system or a storage device comprising a semiconductor memory, a magnetic disc, or the like, hence, high demand for high electric power and a reduced number of components. Use of the power supply device 1A or 1B permits multiphase operation, which achieves high electric power and a reduced number of components.

Or, the power supply device 1A or 1B is applicable to a primary power source in a vehicle such as a car. Here, the power supply device 1A or 1B can directly receive the input voltage V_{IN} from a battery incorporated in a vehicle to produce the output voltage V_{OUT}, and the output voltage V_{OUT} can serve as a driving voltage for a system (e.g., level-3 or higher automatic driving system) incorporated in the vehicle. Or, for example, the power supply device 1A or 1B is applicable to a power source for a charging system. The charging system can be for charging a battery in an electric vehicle. Or, for example, the power supply device 1A or 1B is applicable to a power source for a base station.

For any signal or voltage, unless inconsistent with what is disclosed herein, the relationship between its high and low levels can be reversed as compared with what is specifically described above.

The channel type of any FET (field-effect transistor) mentioned in embodiments is merely illustrative. Unless inconsistent with what is disclosed herein, the channel type of any FET can be changed between P- and N-channel types. Accordingly, for example, the transistors M1 to M4, ML, and MH can be implemented with a P-channel MOSFETs or with N- and P-channel MOSFETs mixed together.

Unless incompatible, any transistor mentioned above can be a transistor of any type. For example, unless incompatible, any transistor mentioned above as a MOSFET can be replaced with a junction FET, IGBT (insulated-gate bipolar transistor), or bipolar transistor. Any transistor has a first electrode, a second electrode, and a control electrode. In an FET, of the first and second electrodes one is the drain and the other is the source, and the control electrode is the gate. In an IGBT, of the first and second electrodes one is the collector and the other is the emitter, and the control electrode is the gate. In a bipolar transistor that is not classified as an IGBT, of the first and second electrodes one is the collector and the other is the emitter, and the control electrode is the base.

Embodiments of the present disclosure allow for any modifications as necessary within the scope of technical ideas recited in the appended claims. The embodiments described above are merely examples of implementing the present disclosure, and what is meant by any of the terms used to describe what is disclosed herein and the components of it is not limited to that mentioned in connection with the embodiments. The specific values mentioned in the above description are merely illustrative and needless to say can be modified to different values.

### Notes

To follow are notes on what is disclosed herein, of which specific examples of configuration are described above as embodiments.

According to one aspect of the present disclosure, a power supply device is a power supply device (1A, 1B) configured to produce from an input voltage (V_{IN}) an output voltage (V_{OUT}) lower than the input voltage. The power supply device (1A, 1B) includes a first converter (10), a second converter (20), and a control circuit (30). The first converter has: a first switching element (M1) provided between a reference node at a lower potential than the input voltage and a first node; a second switching element (M2) provided between the first node and a second node; a third switching element (M3) provided between the second node and a third node; a fourth switching element (M4) provided between the third node and a supply power node fed with the input voltage; a flying capacitor (C_{FLY}) provided between the first and third nodes; an intermediate capacitor (C_{MID}) provided between the second and reference nodes; and a first inductor (L1) provided between the first node and an output node to which the output voltage is applied. The second converter has a switching output stage (21) connected to the second node and a second inductor (L2) provided between the switching output stage and the output node. The control circuit produces the output voltage at the output node by controlling the states of the first to fourth switching elements and of the switching output stage. (A first configuration.)

This provides a power supply device that can perform high-efficiency multiphase operation with a simple structure.

In the power supply device according to the first configuration described above, the control circuit can control the states of the first to fourth switching elements to produce at the second node an intermediate voltage (V_{MID}) corresponding to a division voltage of the input voltage and can perform switching control on the first and second switching elements to make the first converter step down the intermediate voltage; the control circuit can perform switching control on the switching output stage at a different phase from the switching control on the first and second switching elements to make the second converter step down the intermediate voltage; and the control circuit can produce the output voltage at the output node through stepping-down by the first converter and by the second converter. (A second configuration.)

It is thus possible to perform high-efficiency multiphase operation with a simple structure.

In the power supply device according to the second configuration described above, the switching output stage can have a high-side switching element (MH) provided between the second node and a switching node and a low-side switching element (ML) provided between the switching node and the reference node. The second inductor can be provided between the switching node and the output node. The control circuit can perform switching control on the high-side and low-side switching elements at the different phase from the switching control on the first and second switching elements to make the second converter step down the intermediate voltage. (A third configuration.)

In the power supply device according to the third configuration described above, the control circuit can have a first controller (36_1) configured, based on information on the output voltage (V_{FB}) and current information on the first inductor (V_{IL1}), in synchronization with a reference clock signal (CLK1), to turn on and off alternately a pair of the first and third switching elements and a pair of the second and fourth switching elements; and a second controller (36_2) configured, based on the information on the output voltage and current information on the second inductor (V_{IL2}), in synchronization with a shifted clock signal (CLK2), to turn on and off alternately the high-side and low-side switching elements. The shifted clock signal can be a signal obtained by shifting the phase of the reference clock signal. (A fourth configuration.)

In the power supply device according to the fourth configuration described above, triggered by a predetermined level change of the reference clock signal, the first controller can turn on the second and fourth switching elements and turn off the first and third switching elements, and can then, after the lapse of a time (t_{ON1}) corresponding to the information on the output voltage and the current information on the first inductor, turn off the second and fourth switching elements and turn on the first and third switching elements; and triggered by a predetermined level change of the shifted clock signal, the second controller can turn on the high-side switching element and turn off the low-side switching element, and can then, after the lapse of a time (t_{ON2}) corresponding to the information on the output voltage and the current information on the second inductor, turn off the high-side switching element and turn on the low-side switching element. (A fifth configuration.)

In the power supply device according to any one of the first to fifth configurations described above, an output capacitor (C_{OUT}) can be provided between the output node and the reference node. (A sixth configuration.)

In the power supply device according to any one of the first to sixth configurations described above, a plurality of second converters can be provided. (A seventh configuration.)

In the power supply device according to the seventh configuration described above, the control circuit can perform switching control on the switching output stage in each of the second converters at a different phase from the switching control on the first and second switching elements, and the control circuit can perform switching control on every two second converters among the plurality of second converters by performing switching control at different phases on the switching output stage of one second converter and the switching output stage of the other second converter. (An eighth configuration.)

According to another aspect of the present disclosure, a power supply device includes a first converter (10) configured to generate an intermediate voltage (V_{MID}) as a division voltage of an input voltage (V_{IN}) and to step down the intermediate voltage; a second converter (20) configured to step down the intermediate voltage separately from the first converter; and a control circuit (30). The power supply device produces, through stepping-down by the first converter and by the second converter, an output voltage (V_{OUT}) lower than the intermediate voltage. The control circuit makes the first and second converters perform stepping-down at different phases from each other. (A ninth configuration.)

It is thus possible to perform high-efficiency multiphase operation.

1. A power supply device configured to produce from an input voltage an output voltage lower than the input voltage, the power supply device comprising a first converter, a second converter, and a control circuit,
wherein
the first converter has:
a first switching element provided between a reference node at a lower potential than the input voltage and a first node;
a second switching element provided between the first node and a second node;
a third switching element provided between the second node and a third node;
a fourth switching element provided between the third node and a supply power node fed with the input voltage;
a flying capacitor provided between the first and third nodes;
an intermediate capacitor provided between the second and reference nodes; and
a first inductor provided between the first node and an output node to which the output voltage is applied,
the second converter has:
a switching output stage connected to the second node; and
a second inductor provided between the switching output stage and the output node, and
the control circuit produces the output voltage at the output node by controlling states of the first to fourth switching elements and of the switching output stage.

2. The power supply device according to claim 1, wherein
the control circuit controls the states of the first to fourth switching elements to produce at the second node an intermediate voltage corresponding to a division voltage of the input voltage and performs switching control on the first and second switching elements to make the first converter step down the intermediate voltage, and
the control circuit performs switching control on the switching output stage at a different phase from switching control on the first and second switching elements to make the second converter step down the intermediate voltage and produces the output voltage at the output node through stepping-down by the first converter and by the second converter.

3. The power supply device according to claim 2, wherein
the switching output stage has a high-side switching element provided between the second node and a switching node and a low-side switching element provided between the switching node and the reference node, and
the second inductor is provided between the switching node and the output node, and
the control circuit performs switching control on the high-side and low-side switching elements at the different phase from switching control on the first and second switching elements to make the second converter step down the intermediate voltage.

4. The power supply device according to claim 3, wherein
the control circuit has:
a first controller configured, based on information on the output voltage and current information on the first inductor, in synchronization with a reference clock signal, to turn on and off alternately a pair of the first and third switching elements and a pair of the second and fourth switching elements; and
a second controller configured, based on the information on the output voltage and current information on the second inductor, in synchronization with a shifted clock signal, to turn on and off alternately the high-side and low-side switching elements, and
the shifted clock signal is a signal obtained by shifting a phase of the reference clock signal.

5. The power supply device according to claim 4, wherein
triggered by a predetermined level change of the reference clock signal, the first controller turns on the second and fourth switching elements and turns off the first and third switching elements, and then, after a lapse of a time corresponding to the information on the output voltage and the current information on the first inductor, turns off the second and fourth switching elements and turns on the first and third switching elements, and
triggered by a predetermined level change of the shifted clock signal, the second controller turns on the high-side switching element and turns off the low-side switching element, and then, after a lapse of a time corresponding to the information on the output voltage and the current information on the second inductor, turns off the high-side switching element and turns on the low-side switching element.

6. The power supply device according to claim 1, wherein
an output capacitor is provided between the output node and the reference node.

7. The power supply device according to claim 1, wherein
a plurality of the second converters are provided.

8. The power supply device according to claim 7, wherein
the control circuit performs switching control on the switching output stage in each of the second converters at a different phase from switching control on the first and second switching elements, and
the control circuit performs switching control on every two second converters among the plurality of second converters by performing switching control at different phases on the switching output stage of one second converter and the switching output stage of the other second converter.

9. A power supply device comprising:
a first converter configured to generate an intermediate voltage as a division voltage of an input voltage and to step down the intermediate voltage;
a second converter configured to step down the intermediate voltage separately from the first converter; and
a control circuit,
wherein
the power supply device produces, through stepping-down by the first converter and by the second converter, an output voltage lower than the intermediate voltage, and
the control circuit makes the first and second converters perform stepping-down at different phases from each other.
